(19) United States
(12) Patent Application Publication
(10) Pub. No.: US 2007/0280465 A1
(43) Pub. Date: Dec. 6, 2007

(54) METHOD AND DEVICE FOR PROVIDING A SELECTION OPTION FOR ESTABLISHING A COMMUNICATION BETWEEN AT LEAST TWO TERMINALS

(75) Inventor: Michael Greve, Karlsruhe (DE)

Correspondence Address: DARBY & DARBY P.C., P.O. BOX 770, Church Street Station, New York, NY, 10008-0770, US

(73) Assignee: COMBOTS PRODUCT GMBH, Karlsruhe (DE)

(21) Appl. No.: 11/755,896

(22) Filed: May 31, 2007

(30) Foreign Application Priority Data
May 31, 2006 (DE) 10 2006 025 358.2

(51) Int. Cl. H04M 3/42

(52) U.S. Cl. 379/210.02

(57) ABSTRACT

A method and device for providing a selection option for establishing a communication between at least two terminals is provided. The communication is established on a first terminal of at least two terminals in a network. Each terminal has a public mode and a private mode. The public mode indicates that a user of a respective terminal is available as a communication partner to the other terminals. The private mode indicates that spontaneously establishing contacts via a selection of the selection option is not permitted. The other terminals operating in the public mode are detected when the first terminal is set in public mode and made available as a communication partner to the first terminal. At least one piece of identification information pertaining to the other terminals is displayed for selection on the first terminal.

The present application claims priority to German Patent Application DE 10 2006 025 358.2, filed May 31, 2006, the contents of which are hereby incorporated as if set forth in its entirety,

The present invention relates to method for providing a selection option for establishing a communication between at least two terminals, as well as a terminal upon which a selection option is provided for establishing a communication with another terminal.

### BACKGROUND

When a person would like to make contact with another person, for example, who is so far unknown, is currently located in the vicinity, and who has the same interests, the same background or other commonalties, previously known methods require that the other person be directly addressed, in order to find out whether the other person speaks the same language, has the same background and/or other commonalties. This requires substantial effort, since a person who meets the desired requirements can frequently only be found in the surrounding field by repeatedly addressing him/her.

To find a previously unknown person, who is more specifically defined by criteria, Internet databases are available, for example, which allow the user to become acquainted with other people, whether it be for dating purposes or shared sports activities, etc. When using these services, the user is required to enter a profile and is then able to query other stored profiles and selectively choose other people according to selection criteria. The user can then initiate contact with the selected person.

However, such a traditional procedure does not allow for real-time processing; i.e., it is not suited for immediately ascertaining whether one of the people is currently situated in a local surrounding field, nor for immediately establishing contact with this person.

In communication systems, users who are connected to a terminal are frequently represented as a symbol on a display area of the terminal. This symbol can be a figure or also text. By activating the symbol, an appropriate communication connection can be established with the associated communication partner at another terminal, often in the form of an IM communication connection (e.g., instant messaging), a video or voice communication, or in the form of a ComBOT™. ComBOT™ and ComBOTs™ are trademarks of ComBOTS Product GmbH.

As described in the International Patent Application WO 2005/076510, a ComBOTs™ (e.g., a communication robot) is a graphical representation which is provided within a communications application, and allows a communication to be established with another communication partner at any one time. Each communication partner has an assigned ComBOT™, and the two communication partners communicate over an exclusive, preferably encrypted connection between them. There is no address broadcast to the outside world which would enable third parties to reach the communication partners. The communication with the other communication partner in question can be established by selecting the appropriate graphical element; files can be sent using drag-and-drop functions; telephone connections set up; instant messaging carried out, etc.

### SUMMARY

In an embodiment, the present invention provides a method for providing a selection option for establishing a communication between at least two terminals. The communication is established on a first terminal of at least two terminals in a network. Each terminal has a public mode and a private mode. The public mode indicates that a user of a respective terminal is available as a communication partner to the other terminals. The private mode indicates that spontaneously establishing contacts via a selection of the selection option is not permitted. The other terminals operating in the public mode are detected when the first terminal is set in public mode and made available as a communication partner to the first terminal. At least one piece of identification information pertaining to the other terminals is displayed for selection on the first terminal.

### BRIEF DESCRIPTION OF THE DRAWINGS

Exemplary embodiments of the present invention are explained in more detail below with reference to the accompanying drawings in which:

FIG. 1 illustrates a communication range for implementing a method according to an embodiment of the present invention;

FIG. 2 illustrates a terminal in accordance with an embodiment of the present invention;

FIG. 3 illustrates a flow chart for a method according to an embodiment of the present invention; and

FIG. 4 illustrates a flow chart for a method according to an embodiment of the present invention.

### DETAILED DESCRIPTION

In an embodiment of the present invention, a method and a terminal for establishing a communication with another previously unknown user is provided. A selection option is provided for establishing a communication between at least two terminals.

In accordance with an embodiment of the present invention, a method is provided for providing a selection option for establishing a communication between at least two terminals on a first terminal in a network. Preferably, the network is a wireless network. The terminals are operable in a public mode and in a private mode. The public mode of the terminal indicates that the user of the terminal in question is available as a communication partner to at least a second terminal, which is likewise operating in the public mode. The private mode indicates that spontaneously establishing contacts via a selection of the selection option is not permitted. When the public mode is set in the first terminal, at least one second terminal, which is also operating in the public mode, is detected. The second terminal is made available as a communication partner, in that at least one piece of identification information pertaining to the second terminal is displayed for selection on the first terminal. It is to be understood that a plurality of second terminals can also be used.

The terminals may communicate in both modes over one and the same network. Thus, in an embodiment of the present invention, there is no need to switch to a different network when activating or deactivating a mode, in particular, the public mode. The terminals are preferably linked by a communications network, in which the communication partners are each represented by a graphical contact element, symbol or avatar, in particular in the form of a ComBOT™, on the display of a respective terminal.

It is preferred that the terminals feature a device for displaying graphic-based representations of communication partners, in particular ComBOTs™.

In an embodiment of the present invention, the second terminals are preferably detected as follows: When the public mode is set in the first terminal, an information request message is transmitted, prompting the second terminals, which are operating in the public mode, to send public information containing the identification information. The public information messages are subsequently received by the first terminal, and the first terminal sends out its own public information message to the second terminals identified by the relevant identification information,

In an embodiment of the present invention, by selecting one of the displayed identification information messages, the user of the first terminal may open or request a communications connection to the second terminal whose identification information was selected. The identification information may preferably include a position of the terminal in question, which is provided by an automatic position finding or by a manual user input.

In addition, the one or the plurality of second terminals may be provided as communication partners as a function of a distance between the first terminal and the respective second terminal, the distance being ascertained as a function of the positions included in the identification information.

To that end, the manual inputs, in particular, may be evaluated by the user(s). As a result, the process of providing the one or the plurality of communication partners as potential communication partners may be adapted more specifically to the characteristic attributes of the users. An example is a case where a user does not indicate the usual name of the locality, such as “Inn at the Linden Trees,” as a location, but rather the name or nickname known or commonly used in certain circles, such as “at Charlie's,” for example.

In an embodiment of the present invention, the process of providing the one or the plurality of second terminals as communication partners may be carried out as a function of the identification information of the public information received from the second terminals. In addition, the process of providing the one or the plurality of second terminals as communication partners may be suppressed as a function of blocking information.

In accordance with an embodiment of the present invention, the first terminal is not able to transmit any public information to that terminal of the second terminals which is specified by the blocking information. It may also be provided that, once an information request message is received from one of the two terminals, a public information message is transmitted when the first terminal is operating in the public mode.

In accordance with another embodiment of the present invention, a terminal is devised for providing a selection option for establishing a communication with at least one other terminal. The terminal is operable in at least a public mode and in a private mode. The public mode of the terminal indicates that the user of the terminal in question is available as a communication partner to one or a plurality of other terminals. The other terminals are likewise operating in the public mode. The private mode indicates that spontaneously establishing contacts via a selection of the selection option is not permitted.

The terminal preferable includes a transmitting/receiving unit for communicating with the other terminals, and a processing unit which is linked to the transmitting/receiving unit. When the public mode is set in the terminal, the processing unit detects the other terminals, which are operating in the public mode. The terminal also includes a display unit for making available the detected other terminals as communication partners, in that identification information pertaining to the detected other terminals is displayed for selection. Examples of identification information include the name of the ComBOTs™ as well as the current position be indicated, preferably as a distance and directional indication relative to the position of the subject terminal.

In an embodiment of the present invention, since the terminals preferably communicate in both modes over one and the same network, they merely need to conform with one operating mode or network mode. Therefore, the terminal in question may be technically designed or equipped with devices and components very inexpensively. This is due to the fact that there is no need for a transmitting/receiving unit capable of communicating in different networks. Also, no system for switching among various networks is required. When a mode, in particular the public mode, is activated or deactivated, the terminal continues in the operating mode and remains connected to the one network.

Contact between the communication partners is then established by selecting the ComBOT™, and an anonymous communication between the communication partners via their ComBOTs™ can be initiated. In this case, for example, a chat session ma be started, which is then converted into a telephone call, without the communication partners having to mutually give up their anonymity, since, in the case of a ComBOT™, the link information (for example, telephone number) is not displayed. The public mode can also be described as “public ComBOT™” and displayed as a window, for example, within which the other “public ComBOTs™” are displayed.

Both communication partners preferably have the option of blocking the communication with the respective, other communication partner by selecting a function to this effect. It is then no longer possible for the other communication partner to establish contact. This blockade may be carried out situationally for the current session or communication session, i.e., for the time period during which the public mode is selected. The blockade may also be carried out on a permanent basis, i.e., the blocked communication partner, who is then present again, is no longer able to initiate communication for the following sessions of the public mode either. It is preferred that the representation of the subject terminal no longer be displayed then to this blocked communication partner. The blockade may then be canceled again at any time by the person who had set it up.

An embodiment of the present invention relates to a situation where a person having a terminal 1, for example a portable cellular phone or a portable PDA (personal digital assistant), etc., is presently at a location where he/she would like to make contact with another person. In this context, the other person may also be unknown to the subject person. The person, who would like to make contact with another person, may specify the manner in which contact is established with the other person in accordance with a specific selection criterion, such as the language the person speaks, the current location of the other person, as well as in accordance with other information specific to the person, such as name, age and gender, as well as preferences, hobbies and the like, for example.

In particular, the current location of the other person is important for the subject person who is seeking an immediate communication partner. Thus, it is beneficial that other people, who have corresponding other terminals 2 and who are located within a radius K of the current position of the subject person or of his/her terminal 1, be made available for selection to the subject person via his/her corresponding terminal 1. In this example, it is intended that people having other terminals 3 located outside of radius K not be indicated as potential communication partners.

The current positions of terminals 1, 2, 3 of the subject person or of the other people may be ascertained, for example, using a position finding system in the terminal, such as a GPS receiver, for example.

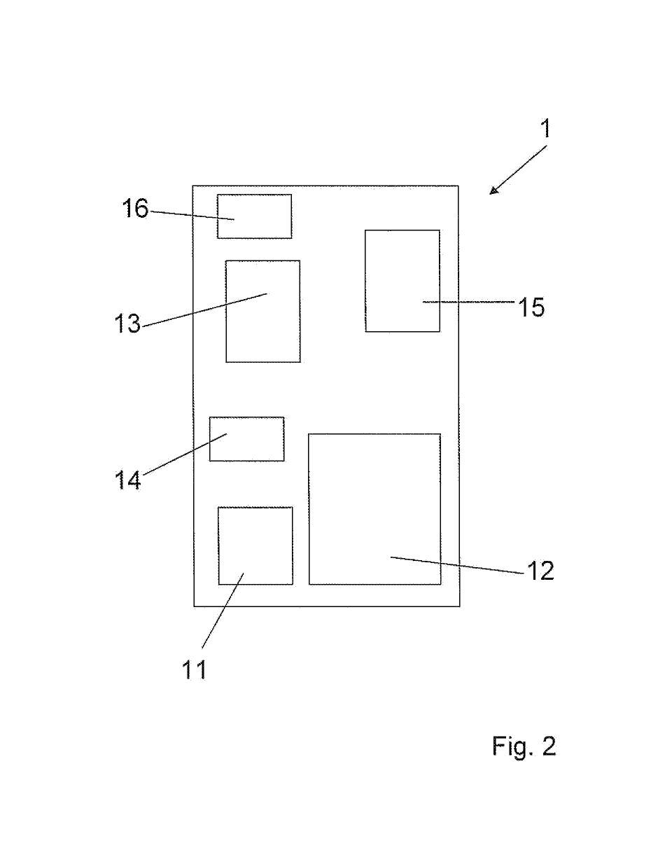

A terminal 1 in accordance with the present invention is schematically shown in FIG. 2. Terminal 1 includes a processing unit 11, a transmitting/receiving unit 16, as well as a display unit 12. With the aid of processing unit 11 and transmitting/receiving unit 16, communications functions may be carried out with one or a plurality of other terminals 2. Possible communications functions include, for example, functions for carrying out an IM communication (instant messaging), a telephone session, a video telephony session, or some other type of communication. A selection of potential communication partners may be displayed on display unit 12 with the aid of processing unit 11, for example, allowing the user to select his/her communication partner on the basis of a graphical representation of respective other terminal 2 of one or a plurality of other people.

The communication partners are preferably presented as so-called ComBOTs™ which are representations that are assigned, in this particular case, to other terminal 2 of the other user. This means that graphical representations, which stand for terminals 2 of the other users and which have preferably been defined by the other users in question, can be displayed on terminal 1.

Thus, depending on user input, terminal 1 may be operated in a public mode or in a private mode. In the private mode, terminal 1 performs its usual functions. For example, in the case of a cellular phone, it may execute the calling function or the called function, and may also provide other functions. In particular, terminal 1 resides in an operating mode for transmitting, respectively for communicating in a ComBOT™ network. This means that each user is displayed on the terminal of his/her contact or communication partner, as a pictorial or graphical, animatable figure or avatar, referred to as a ComBOT™.

The appearance and properties thereof, particularly with regard to the animation options, may preferably be defined by the user. Two users can then communicate directly and privately via the ComBOTs™ displayed on the terminals. The ComBOTs™ may be downloaded from a web site or an on-line shop, or obtained via other avenues.

As an example, the first user of first terminal 1 has selected a ComBOTs™ in the form of a dragon, which appears on the display or desktop of second terminal 2 and represents the first user thereon, it being possible to also add the name of the first user, for example “Jim,” to the ComBOT™. The second user, whose name is “Bob,” for example, may be represented on the first terminal as a “mouse,” including the name label “Bob.” For each contact, a personal ComBOT™ of this kind is provided on the display. Thus, the personal or private contacts of every user are visually presented to him/her as ComBOTs™, particularly in the private mode.

A direct and private communication can be opened by clicking and/or by using drag-and-drop commands on the desired ComBOT™. Moreover, in accordance with an embodiment of the present invention, other potential contacts or communication partners may now be found in the public mode and shown on the display, in particular as anonymous or partially anonymous ComBOTs™, which, at least initially, only appear without names or other personal information. Thus, each user signals or indicates that he/she is ready to make a news contact. In the private mode, the pictorial representations, i.e., the ComBOTs™ , include personal information, in particular the name of the user in question. On the other hand, in the public mode, at the least, the pictorial representations do not include the name of the particular user.

In the public mode, on the one hand, other terminals 2 are available as communication partners to terminal 1, and terminal 1 can detect other terminals 2 which are likewise operating in the public mode. Other terminals 2 are displayed as ComBOTs™ on display unit 12 of terminal 1, so that, by selecting the particular ComBOTs™ with the aid of an input unit 15, the subject user may select the other user of other terminal 2, to which this ComBOTs™ is assigned, as a communication partner and may carry out a communication in conformance with the type of communication selected by the user.

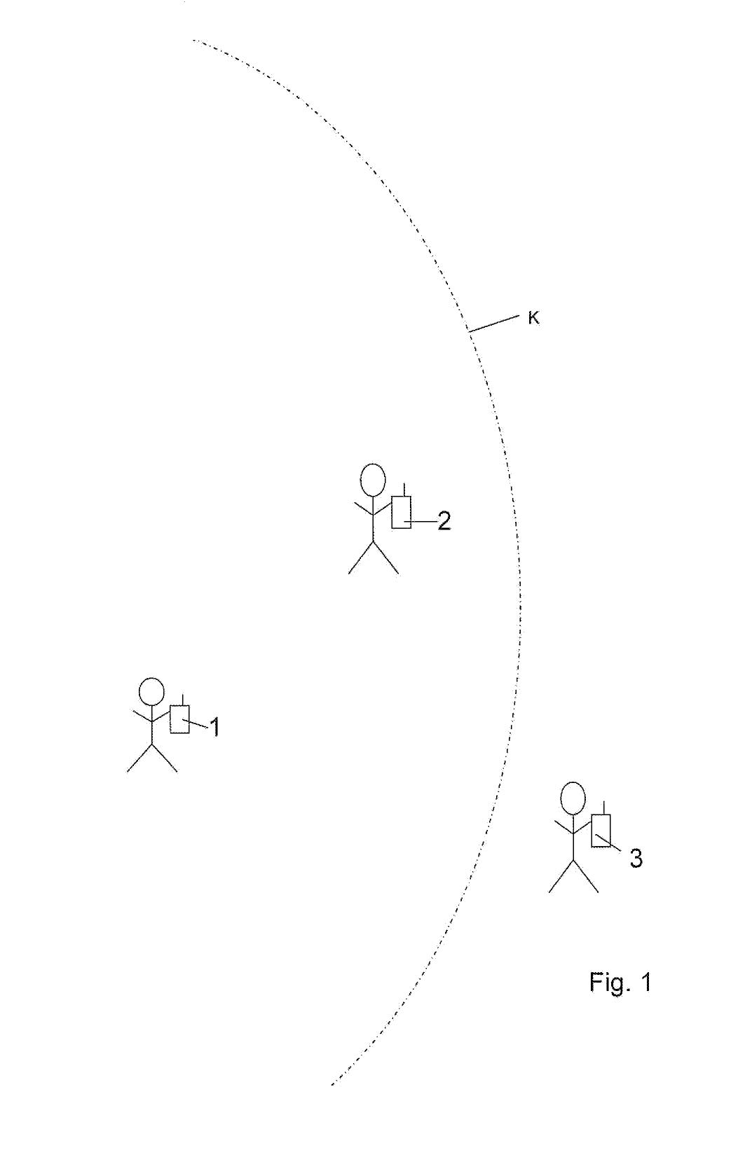

If positional information regarding the current position of the terminal in question is made available in terminals 1, for example via a GPS receiver 13 or by the subject user manually inputting the same into terminal 1, then, on the basis of the positional information of terminal 1 and that of other terminals 2, a selection may be made among other terminals 2 as a function of the relevant positional information. In particular, only those other terminals, which are located within a defined radios or range of terminal 1, as illustrated in FIG. 1, may be displayed for selection on display unit 12. This may be effected by a distance determination, for example, with the aid of the positional information of terminal 1 or of the other terminals. However, the selection of the communication partners may just as well be limited to only the users of those other terminals currently situated as a specific location that is not predefined by the location of the user of terminal 1.

As an example, when a communication partner is selected via the displayed ComBOTs™ on display unit 12, an IM communications program may be started in terminal 1 that makes possible an instant messaging with the selected communication partner. From the level of this function, a telephone call or a video telephony session, etc. may also be started. Due to the fact that communication is carried out merely over the ComBOT™, the telephone number of the other person with whom communication is taking place, is not known at this point in time, since the other person or the corresponding other terminal 2 is merely identified as a ComBOT™, i.e., as a pictorial representation on display unit 12 of terminal 1 of the user. This allows the communication partners to initially remain anonymous, in spite of the existence of a communications connection, so that the contacted communication partner, i.e., the person having other terminal 2, for example, may withdraw from or cancel the communication at any time, without disclosing further identification data, such as his/her telephone number.

In an embodiment of the present invention, to prevent terminal 1 from being contacted in the public mode by a specific terminal 2 of another user, the specific terminal 2 may also be blocked. Thus, although terminal 1 is operating in the public mode, the blocked terminal 2 is not displayed as a potential communication partner. This is accomplished by assigning a pseudonym to the ComBOT™, or by selecting the ComBOTs™ using a specific function which blocks other terminal 2 identifiable by the ComBOTs™ or the pseudonym. The user of terminal 1, who has blocked another terminal 2, may be informed of its presence within a predefined radius, for example, by a slash through the ComBOTs™ on display unit 12. Thus, the person who is assigned to the slashed-through ComBOTs™ nay be temporarily or permanently blocked. However, the blocking may also be canceled by selecting the slashed-through ComBOT™.

In addition, terminal 1 of the user executing the blocking function is not shown on display unit 12 of the other terminal 2, so that the user executing the blocking function is not available as a communication partner to the user of other terminal 2, although terminal 1 is operating in the public mode.

In an embodiment of the present invention, the selection of other terminals 2, which is shown on display unit 12, may be supplemented with positional information, such as the distance of other terminal 2 from terminal 1 and its direction relative thereto. Thus, merely by glancing at display unit 12, the user of terminal 1 is able to discern in which direction and at what distance the next person is located who has a terminal 2 operating in the public mode. Thus, for example, a user of such a terminal 1 may go to a public place and activate his/her ComBOT™, i.e., set terminal 1 to the public mode. The display then indicates to him/her, for example, that another terminal 2 of another person is present at a distance of approximately 70 meters over a range of 270°. The user of terminal 1 may then initiate contact with the person of other terminal 2 and, subsequently thereto, possibly phone or meet the person.

In the same way, one may block the other person after having communicated with or phoned him/her, and thus is no longer available to this person as a possible contact; i.e., one's own ComBOTs™ is no longer displayed on the display unit of other terminal 2. Thus, one may remain available to terminals which are not blocked, since one is still actively in the public mode, but no longer be available as a communication partner for the blocked persons.

In an embodiment of the present invention, it is possible to store a profile in a memory unit 14 of terminal 1, i.e., in connection with one's own ComBOT™, that may specify identification information pertaining to oneself and/or information regarding the characteristic traits of desired communication partners, the communication partners specified for selection being selected as a function of the profiles. This means that potential communication partners can be displayed on display unit 12 not only as a function of their current position, but also as a function of their associated profile data.

For example, the user of terminal 1 may create a profile indicating that he/she would only like to have those people who speak German included in the display. He/she may then set his/her terminal 1 to operate in the public mode and consequently search for further people having corresponding other terminals 2, whose terminals 2 are likewise operating in the public mode, and who speak German. By selecting the location or destination where the user of terminal 1 is traveling to, to activate the public mode of the terminal, the user may influence the kind of people he/she will encounter. Thus, it is possible, for example, for a user of the terminal to seek hiking partners and, for that purpose, to first travel to a valley station in a mountain range, in order to determine there who will be displayed as a possible contact partner in the selection list on display unit 12 of his/her terminal and who likewise seeks contact or would like to be addressed, which he/she makes known by the public mode of his/her other terminal 2.

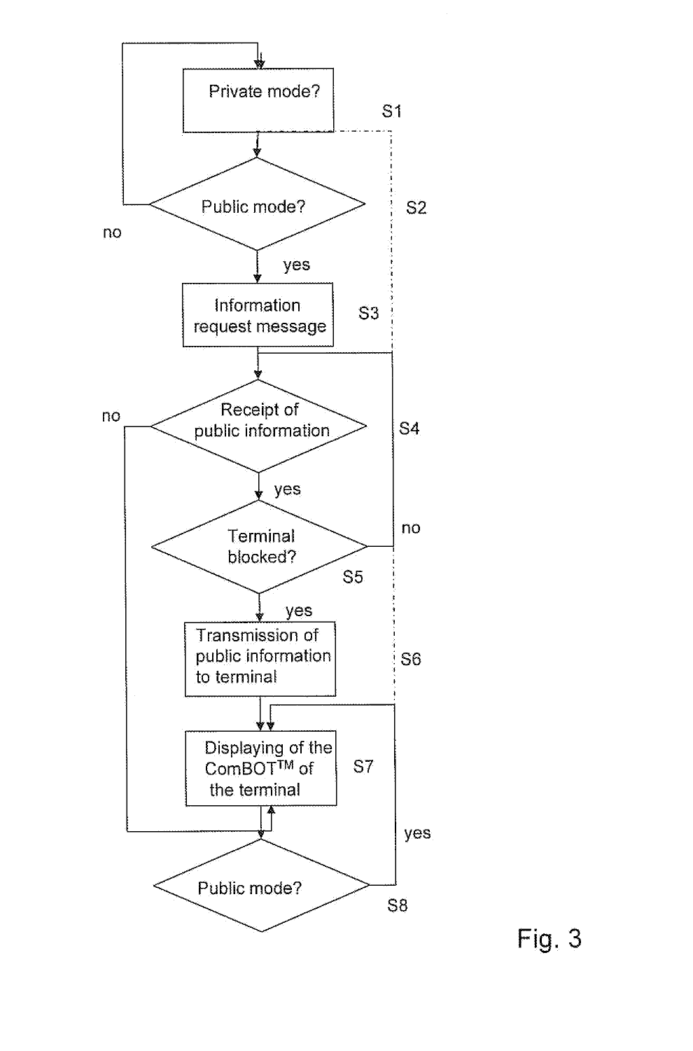

To further clarify a method according to an embodiment of the present invention, a flow chart for illustrating the method is shown in FIG. 3. At the beginning (step S1), terminal 1 is operating in the private mode, i.e., it is executing functions of a terminal that are typical and known per se, such as those of a cellular phone or of a PDA, for example.

In step S2, it is now queried whether the user would like to switch to a public mode, which he/she indicates by making an input to this effect in input unit 15 of terminal 1. If the public mode is not chosen, terminal 1 remains in the private mode.

When terminal 1 is reset to the public mode, an information request message is transmitted to other terminals 2 prompting them to communicate whether or not they are operating in the public mode (Step S3). The information request message is communicated to other terminals 2 which are located within a defined radius K around terminal 1. There are a variety of ways to accomplish this. For example, a radio signal having a limited range may be transmitted along with the information request message, so that only those other terminals 2 located within the range are able to receive the radio signal. Thus, in this example, the range of the radio signal determines the number of potential communication partners and the radius within which they are located. The current position of terminal 1 may also be automatically determined, for example with the aid of GPS receiver 13, or by using an identification number of a base station where subject terminal 1 is logged on and within whose range it is located. The current position of terminal 1 may also be manually inputted by the user of terminal 1.

In addition, in the same way as other information to be transmitted, as will be discussed below, the information request message may also be transmitted indirectly via the base station to other terminals 2 or, as the case may be, to terminal 1, when terminal 1 is a cellular phone, for example, in that the base station relays the information request message of terminal 1 to all other terminals 2 which are logged onto the base station in question.

At this point, upon receiving the information request message, other terminals 2, which are operating in the public mode, may send public information as notification of operation in the public mode indirectly (see above) or directly, to be received by terminal 1 (Step S4). The public information may be transmitted using the same or different method as that used to transmit the information request message provided in step S3. The public information, which is sent out by each of other terminals 2, may include corresponding identification information defining the ComBOTs™ display, and data, such as name, address, hobbies, current position, for example, as well as contact information indicating the characteristic traits the desired selectable communication partner should have with respect to hobbies, age, gender, interests, language, etc.

If public information is received in step S4, each of received other terminals 2 is polled in a query S5 to check whether terminal 2 in question identified by the user of terminal 1 on the basis of the identification information, is blocked or not. This is indicated by blocking information. If it is blocked, then there is no confirmation of the public information being received. In addition, the other terminals 2 are checked to determine whether the identification information contained in the public information thereof conforms with the contact information specified by the user of terminal 1. If not, then those communication partners are also blocked, i.e., those whose contact information does not conform with the user's specifications.

If other terminal 2 is not blocked, the reception is confirmed (step S6) by terminal 1 sending out its own public information to terminal 2 in question, which is not blocked and which has made itself available as a communication partner (step S6). In addition, the ComBOTs™ is added to a selection list, which reveals those ComBOTs™ which are not blocked and specifies those terminals 2 which are operating in the public mode.

At this point, other terminals 2, which are not blocked and which are operating in the public mode, are displayed on display unit 12 of terminal 1 (step S7). Thus, the user of terminal 1 is given an option to select one of the people of other terminals 2 as communication partners. The communication with the corresponding communication partners may be initiated by selecting a specific type of communication and by selecting the corresponding ComBOTs™ assigned to other terminal 2.

It is preferred that steps S4, S5, S6 and S7 are repeated until no more public information is received from another terminal. At this point, identification data is available in terminal 1 for each other terminal 2 which is located within the range of terminal 1, respectively within the radius defined by the user of terminal 1, and which is operated in the public mode.

If another terminal 2, which is already included in the selection list, is to be blocked, then delete information to this effect may be provided. The delete information can be sent to the other terminal to be blocked in order to delete the user of terminal 1 from the selection list provided there, or to stop the potential communication partners from being displayed. Alternatively or additionally thereto, a communication attempt made by other terminal 2 may be rejected as a function of the blocking information provided in terminal 1.

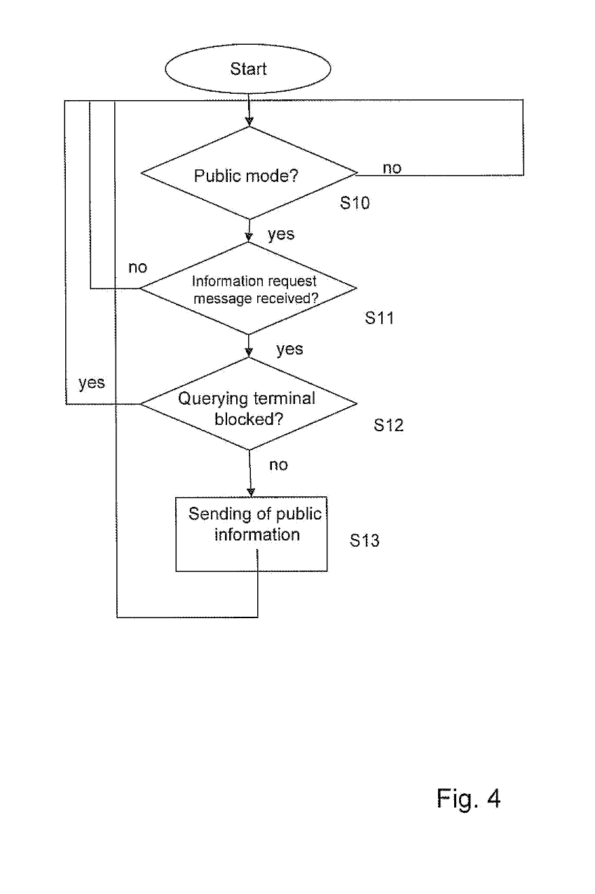

With reference to FIG. 4, it is checked in terminal 1 by processing unit 11 in accordance with step S1 whether terminal 1 is continuing to operate in the public mode. For as long as it is operating in the public mode (step S11), a check test is continuously performed in accordance with step S11 to determine whether an information request message from another newly added terminal 2 is received. The information request message is checked on the basis of the existing blocking information to determine whether terminal 2 in question should be blocked or not (step S12). Confirmation of reception is only made by sending out public information (step S13) when it is not intended for terminal 2 in question to be blocked, and newly added terminal 2 is then added to the selection list on display unit 12.

It may be checked from time to time (broken line in FIG. 3) to determine whether the communication partners shown in the selection list are still available in that an information request message is sent out again, which is received by the users in question of other terminals 2. If the terminals in question are still active and are operating in the public mode then a confirmation message to this effect is sent back to indicate that one is still available as a communication partner. If terminal 2 in question is no longer operating in the public mode, then no public information is received and, as a result, terminal 1 recognizes that the communication partner is no longer available and deletes the same from the selection list.

While the invention has been particularly shown and described with reference to preferred embodiments thereof, it will be understood by those skilled in the art that various changes in form and details may be made therein without departing from the spirit and scope of the invention.

What is claimed is:

1. A method for providing a selection option for establishing a communication between at least two terminals on a first terminal of the at least two terminals in a network, the method comprising the steps of:
providing a public mode and a private mode for each of the at least two terminals, the public mode indicating that a user of the respective terminal is available as a communication partner to a second terminal of the at least two terminals, and the private mode indicating that spontaneously establishing contact via a selection of the selection option is not permitted;
detecting, when the first terminal is set to the public mode, the second terminal operating in the public mode;
making the detected second terminal available as a communication partner by displaying, for selection on the first terminal, an identification informational pertaining to the second terminal.

2. The method as recited in claim 1, wherein the network is a wireless network.

3. The method as recited in claim 1, wherein the step of detecting the second terminal is performed by the steps of:
prompting the second terminal to transmit first public information including the identification information by transmitting an information request message when the first terminal is set to the public mode;
receiving, by the first terminal, the first public information; and
transmitting, by the first terminal, second public information to the second terminal identified by the identification information.

4. The method as recited in claim 1, further comprising the step of:
requesting a communication connection to the second terminal by selecting the displayed identification information.

5. The method as recited in claim 1, wherein the identification information includes a position of the second terminal.

6. The method as recited in claim 5, further comprising the step of:
providing the position of the second terminal by an automatic position finding.

7. The method as recited in claim 5, further comprising the step of:
providing the position of the second terminal by manual user input.

8. The method as recited in claim 5, wherein the step of making the second communication terminal available as a communication partner is performed based on a distance between the first terminal and the second terminal, and further comprising the sep of ascertaining the distance as a function of the position included in the identification information.

9. The method as recited in claim 3, wherein the step of making the second terminal available as a communication partner is performed based on the identification information of the public information received from the second terminal.

10. The method as recited in claim 1, further comprising the step of:
suppressing, based on blocking information, an availability of the second terminal as a communication partner.

11. The method as recited in claim 10, wherein the first terminal does not transmit any public information to the second terminal when the availability of the second terminal as a communication partner has been suppressed.

12. The method as recited in claim 1, further comprising the step of:
transmitting, when the first terminal is operating in the public mode, a public information message upon a receiving of an information request message from the second terminal.

13. The method as recited in claim 1, wherein the at least two terminals communicate both in the private mode and public mode over at least one of the same network and the same communication system.

14. The method as recited in claim 1, wherein the step of displaying includes showing, on a first display unit of the first terminal, a second user of the second terminal as a second pictorial representation assigned to the second user, and further comprising showing, on a second display unit of the second terminal, a first user of the first terminal as a first pictorial representation assigned to the first user.

15. The method as recited in claim 14, wherein;
in the private mode, each pictorial representation comprises personal information, and
in the public mode, each pictorial representation does not comprise a name of the respective user.

16. The method as recited in claim 15, wherein the personal information comprises a name of the respective user.

17. The method as recited in claim 14, wherein the step of detecting the second terminal is performed by the steps of:
prompting the second terminal to transmit second public information including the identification information by transmitting an information request message when the first terminal is set to the public mode;
receiving, by the first terminal, the second public information; and
transmitting, by the first terminal, first public information to the second terminal identified by the identification information;
and wherein, in the public mode, the first pictorial representation is determined by the first public information, and the second pictorial representation is determined by the second public information.

18. The method as recited in claim 17, wherein each of the pictorial representations is determined by respective data specified by the respective first or second user.

19. The method as recited in claim 1, further comprising the steps of:
establishing a position of the first terminal;
establishing a position of the second terminal;
determining if the position of the second terminal is within a radius of the position of the first terminal;
providing the second terminal as a communication partner based upon whether the second terminal is within the radius of the position of the first terminal.

20. A terminal for providing a selection option for establishing a communication with at least one other terminal, the terminal comprising:
a transmitting/receiving unit operable to communicate with the at least one other terminal;
a processing unit linked to the transmitting/receiving unit, the processing unit being operable in a public mode and a private mode, the public mode indicating an availability of a user of the terminal as a communication partner to the at least one other terminal, the private mode indicating that spontaneously establishing contact via a selection of the selection option is not permitted, the processing unit being operable to detect the at least one other terminal operating in the public mode when the processing unit is operating in the public mode; and
a display unit operable to display a respective identification information pertaining to a detected other terminal so as to enable a selection of the detected other terminal as a communication partner.
